(19) United States
(12) Patent Application Publication
(10) Pub. No.: US 2008/0094825 A1
(43) Pub. Date: Apr. 24, 2008

(54) Electroluminescent Candle

(76) Inventor: Norman L. Silver, Philadelphia, PA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 11/550,632

(22) Filed: Oct. 18, 2006

(51) Int. Cl. F21V 35/00

(52) U.S. Cl. 362/161

(57) ABSTRACT

An electric candle includes a candle-shaped frame which features both a simulated candle flame and having illumination from the side area of the length of the electric candle. The side illumination is provided using an electroluminescent panel. The panel being actuated via a switch optionally located within a membrane of the panel. A controller circuit is used to provide a sequential actuation of various elements within the electroluminescent panel that results in a display pattern for the electric candle as well as additional illumination.

### FIELD OF THE INVENTION

The present invention relates generally to electrical novelty devices, and more particularly to an electric candle incorporating electroluminescent technology.

### BACKGROUND OF THE INVENTION

There currently exist electric candlesticks having a simulated flame and standard electric cord and plug for connection with a conventional household outlet. There also exist electric candlesticks that include a power source, such as a battery, within the lamp that provide power for the simulated flame. These type of devices simulate a classic candle which is illuminated at only one location. Specifically, classic wax candles are illuminated only at the top; a location where a candle wick may be located. This location makes sense in that the top of a real wax candle is a prime wick location in order to preserve the life of the candle as the wick burns. Although multiple wick candles exist, the wicks are generally always located at the top of the candle. Thus, electric simulation real wax candles has typically included a source of illumination that is located only at the top of the candle.

Such classic candle simulations are well known. However, a more modern version of a decorative electronic simulated candle can offer variety and additional functionality. Therefore, it can be appreciated that there exist a need for a new and improved electric candle which offers more types of illumination that the standard electric simulation of a wax candle with a burning wick.

### SUMMARY OF THE INVENTION

The present invention embodies an electric candle which includes a candle-shaped frame having a top end, a bottom end, and a length. The electric candle includes a light emitting device affixed to the upper end of the candle-shaped frame to simulate light from a flame and an electroluminescent panel wrapped around the candle-shaped frame. An electronic control unit is used to actuate both the light emitting device and the electroluminescent panel. The electronic control unit acts to drive the electroluminescent panel the panel along a portion of the length of the candle-shaped frame.

Other aspects of the invention include the separate illumination of different items or patterns along the length of the candle-shaped frame by virtue of the electroluminescent panel design. The action of the electronic controller is responsible for the final illumination sequencing of patterns or items built into the electroluminescent panel. A switch for the actuation of the functions of the electroluminescent candle may also be available as a membrane switch built into the electroluminescent panel.

Traditional wax candles, and various types of electric candles, may include decorative and/or seasonal, and/or promotional designs on the outside surface of the candles. The present invention illuminates such exterior decoration using an electroluminescent panel. Although there exist wax candles with secondary embedded light sources which may illuminate exterior designs by means of an interior-originating light source, the present invention allows for such designs to be illuminated and/or animated on the panel surface of the candle.

### BRIEF DESCRIPTION OF THE DRAWINGS

For the purpose of illustrating the invention, there is shown in the drawing(s) a form that is presently preferred; it being understood, however, that this invention is not limited to the precise arrangements and instrumentalities shown.

FIG. 1 illustrates an example assembled view of an electroluminescent candle in accordance with the present invention;

FIG. 2 illustrates an example pre-assembled view of a taper style of electroluminescent candle in accordance with the present invention;

FIG. 3 illustrates an example pre-assembled view of a votive style of electroluminescent candle in accordance with the present invention;

FIG. 4 illustrates example EL panels and designs;

FIG. 5 illustrates an example drive circuit for an electroluminescent panel in accordance with the present invention; and

FIG. 6 illustrates an alternate embodiment of an electroluminescent candle.

### DETAILED DESCRIPTION OF ILLUSTRATIVE EMBODIMENTS

The present invention includes a novel design for an electric candle that incorporates technology not previously used in conjunction with candles that are intended to simulate classic wax candles. The present invention includes the use of electroluminescent panel technology in conjunction with a classic candle-shaped frame and functionality. A brief description of electroluminescent technology is instructive to understand the present invention.

Electroluminescence (EL) is an optical phenomenon and electric phenomenon where a material emits light in response to an electric current passed through it, or to a strong electric field. This is in distinction to light emission resulting from heat (incandescence) or from the action of chemicals (chemiluminescence). Typically, electroluminescent (EL) devices, such as EL panels, use phosphor-based luminescence and are frequently used as backlights to liquid crystal displays. They readily provide a gentle, even illumination to the entire display while consuming relatively little electric power. This makes them convenient for battery-operated devices such as pagers, wristwatches, and computer-controlled thermostats and their gentle green-cyan glow is a common sight in the technological world. They do, however, require relatively high voltage. For battery-operated devices, this voltage is typically generated using a DC to AC inverter which functions to change a DC battery voltage to about 50 to 250 Volts AC. For line-voltage operated devices (typically 120V AC), the AC power may be supplied directly from the power line. Electroluminescent night lights operate directly from AC in this fashion.

In either case, the EL material, such as phosphor, is enclosed between two electrodes and at least one electrode is transparent to allow the escape of the produced light. A glass or plastic coating with indium oxide or tin oxide is commonly used as the front (transparent) electrode while the back electrode is or is coated with reflective metal. Thus, the basic EL element resembles an electric capacitor having two conductive plates separated by a light emitting phosphor material. When AC voltage is applied, the phosphor will then rapidly charge and discharge, resulting in the emission of light. The brightness and color of the light depends on the chemical composition and dye pigments of the phosphor.

Unlike neon and fluorescent lamps, electroluminescent panels are not negative resistance devices so no extra circuitry is needed to regulate the amount of current flowing through them. Electroluminescent panels may have segregated areas corresponding to different electrodes or capacitor-like areas with separate leads that allow one portion of the panel to be illuminated independently from another portion of the panel. Electroluminescent panels can be made in any color, such as white, blue, blue-green, green, and orange. Other simulated colors are possible by tinting the color of the clear electrode.

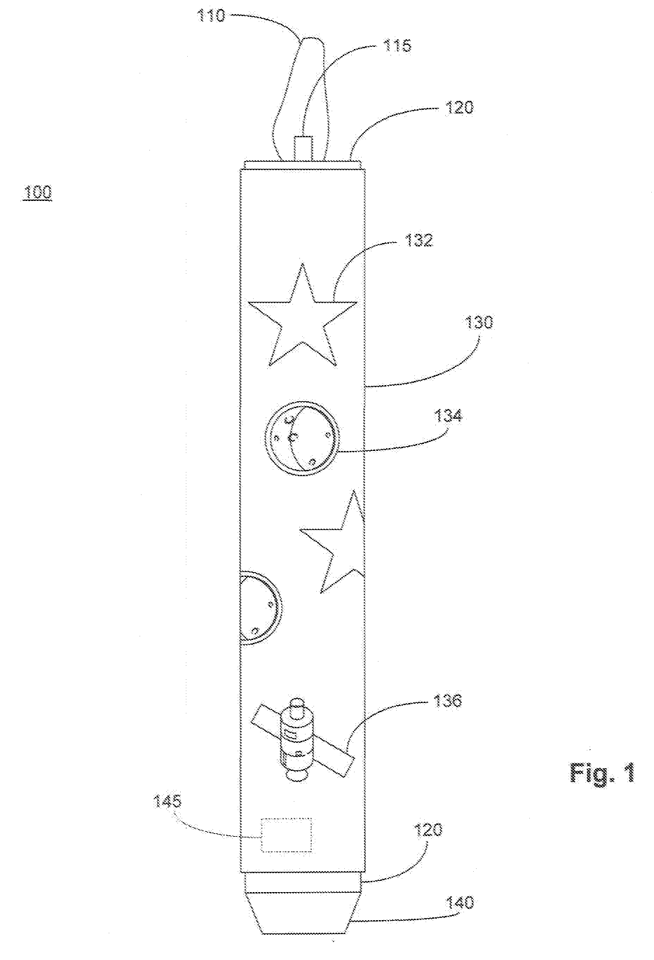

Electroluminescent panels have been used as flat signs or as decorative items attached to clothing such as jackets or portable items such as handbags. However, the use of electroluminescent panels has not been in use as a source of additional illumination and decoration on a candle-like frame as is the current invention. FIG. 1 depicts one embodiment of the current invention. An electroluminescent (EL) candle 100 includes a candle-shaped frame 120 having a simulated flame 110 with a light 115 to simulate a burning candle flame. The EL candle 100 also features an electroluminescent panel 130 which is wrapped over the candle-shaped frame 120 such that the electroluminescent panel 130 takes the form of the candle-shaped frame 120.

The electroluminescent panel includes a pattern on the side of the candle, around the circumference of the candle-shaped frame, and the pattern is illuminated by control circuitry (not shown). For example, the pattern may include multiple independently illuminated items such as items 132, 134, and 136. One characteristic of an electroluminescent panel is that it may be designed so that pattern items 132, 134, and 136 have electric connections to a controller that allow the independent illumination of each item or the simultaneous illumination of the pattern items or some combination therein. Thus, the EL candle 100 retains a capability to illuminate each pattern item on and off in timed sequence or together, or in groups according the design parameters. Such design parameters allow for a functional sequencing where all pattern items are illuminated in turn or a sequencing which allows a purely aesthetic or even random illumination. When an ordered sequencing is used, the design may be considered to become a simulated animation of a pattern object. In addition, the light 115, which can be any of a light emitting diode, a neon light, an incandescent bulb, and a small electroluminescent panel portion, is typically illuminated along with the electroluminescent panel 130.

The EL candle is novel for a variety of reasons. Illuminating a candle along the side length of a candlestick shaft or a side of the candle body is not the typical lighting mode for a candle. Illumination from a flame or a flame simulation is typically limited to only the top of the candle and not from the side of the candle body. Although a candle may appear to be illuminated along the side by placing a light source inside a transparent or translucent candle body, the present invention illuminates the side of a candle body from the candle-shaped panel surface and not from within the candle body itself.

The example of FIG. 1 also includes a candle bottom 140 shaped to allow the EL candle 100 to be placed in a standard candle holder. The tapered candle bottom 140 may also serve as a control switch. Such a switch allows control of the EL candle in several modes. For example a rotary switch designed into bottom 140 having multiple detent positions may include positions of off, wick light 115 on, electroluminescent panel 130 on, wick and electroluminescent panel 130 on, and a position which allows selection of a frequency of sequencing the electroluminescent panel 130. In an alternative embodiment, the switch may be a switch internal to the EL candle 100 which is activated by a infrared (IR) or frequency modulated (FM) transmission device located outside of the EL candle. In other alternative embodiments, the switch may be a switch that is actuated by any of a timer, a sound sensor, a motion sensor, a light sensor, and a touch sensor.

In another embodiment, the control switch for the electroluminescent panel 130 can be a membrane-type switch 145 located on the electroluminescent panel 130 itself. Thus, one or more switches may be easily actuated by simply depressing the membrane switch on the side of the electroluminescent panel 130 on the candle-shaped frame 120. As is well known in the art, the membrane-type switch may also be used to cycle though control options as discussed above with respect to rotary bottom switch 140.

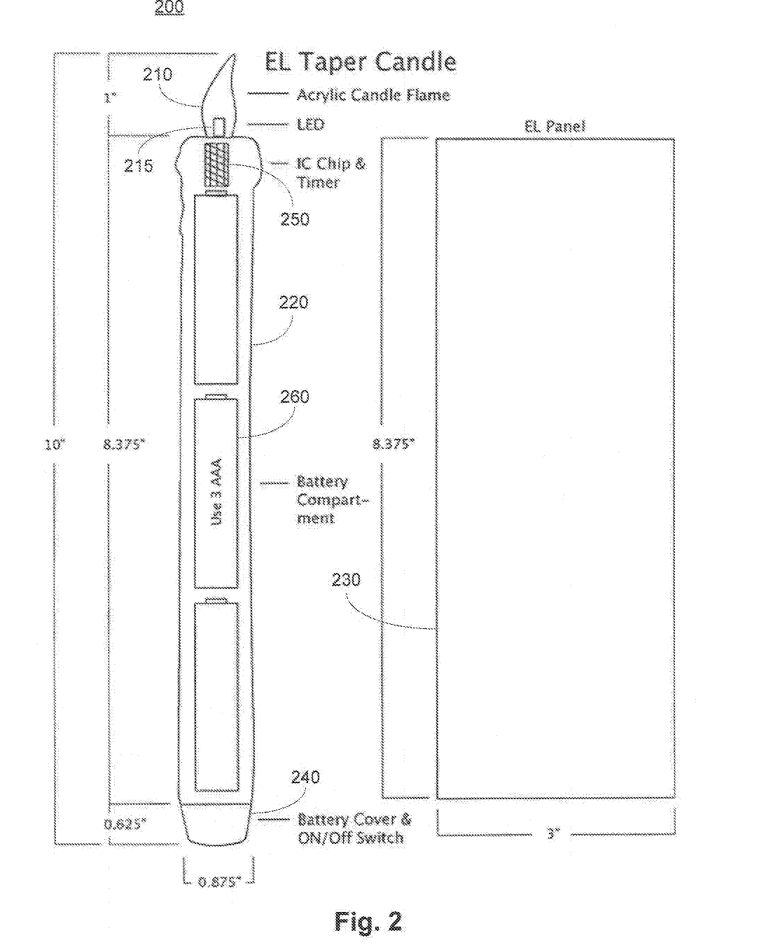

FIG. 2 shows a pre-assembly depiction 200 of an EL candle that favors the shape of a standard tapered candle. The step remaining in the assembly is the attachment of the electroluminescent panel 230 to the candle-shaped frame 220. The candle-shaped frame 220 is formed to resemble a tapered candle and may be made of any suitable material, such as plastic, glass, ceramic, wax, paper, a polymer, wood, fiberglass, or any other materials that are able to be shaped into a candle-shaped frame 220. In general, a candle-shaped frame is an object, formed to represent a candle, that serves as a frame onto which an electroluminescent panel may be attached. As such, a candle-shaped frame includes all shapes of candles including standard (traditional) candle shapes (as in taper, votive, tea light, and pillar), as well as novelty candle shapes having a generally circular (as in the shape of a fruit or vegetable) or geometric shape (as in triangles, pyramids, cylinder, sphere, or cones). In the instance of FIG. 2, the specific type of candle frame used is a traditional taper candle.

In FIG. 2, a simulated flame 210 having a light 215 is located at the top of the candle-shaped frame 220. The simulated flame may be fabricated using any transparent material such as clear plastic, a clear polymer, such as acrylic, glass, crystal, wax, or other suitable materials. The simulated flame may also take the form of a wire outline, a paper form, or plastic picture or representation of a flame or a symbolic flame.

FIG. 2 also depicts one possible orientation of an integrated circuit controller device 250, a power source, 260, such as one or more batteries, and a control switch 240. The electroluminescent panel 230 is shown in the pre-assembly view of FIG. 2 as a full length panel. However, any portion of the length of the candle-shaped frame 220 may be wrapped in the electroluminescent panel 230 and still comport with the principles of the current invention. Not shown in FIG. 2 are the connections of the electroluminescent panel 230 to the controller 250. Typically, an electroluminescent panel 230 will have thin, flat, layered or possibly flexible printed circuit-like electric connections or light-weight wire connections. One of skill in the art of electric device assembly will easily recognize that the connections of the electroluminescent panel 230 can be made by routing the panel connections through a hole in the candle-shaped frame 220 to connect to the electronic controller 250. As understood from above, the number of connections may vary based on the number of individual design items that are to be illuminated on the electroluminescent panel 230. The light 215 as well as the switch control 240 and batteries 260 are also interconnected to the controller 250 as is well understood by those of skill in the art.

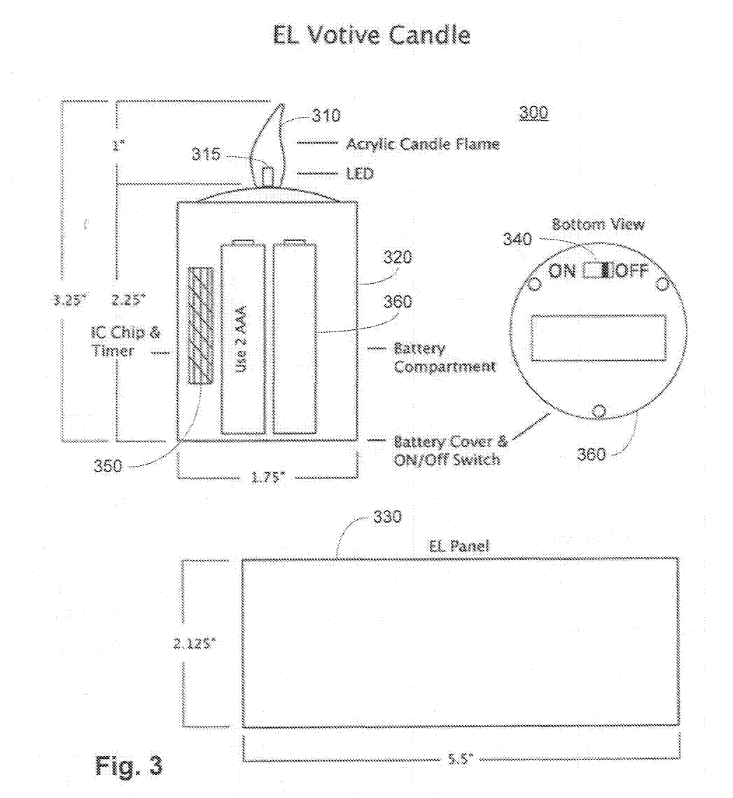

FIG. 3 is another example embodiment of the current invention. FIG. 3 depicts a pre-assembly depiction 300 of an EL candle that favors the shape of a standard votive-like candle. The step remaining in the assembly is the attachment of the electroluminescent panel 330 to the candle-shaped frame 320. The candle-shaped frame 320 is formed to resemble a votive candle. The attachment of the electroluminescent panel 330 to the candle-shaped frame 220 can be made by any means known to those of skill in the art. For example, an adhesive applied to attach the electroluminescent panel 330 to the candle-shaped frame 320 may be applied to the back of the electroluminescent panel 330. The adhesive can be any adhesive such as a two part contact cement, an epoxy, a double sided film adhesive placed between the electroluminescent panel 330 and the candle-shaped frame, or a pre-applied film adhesive on either the electroluminescent panel 330 or the candle shaped frame 320. The panel may also be applied to the form using a functional joining element or functional and aesthetic tape (not shown) along the seam formed after the electroluminescent panel 330 is wrapped around the candle-shaped frame 320. Another option is a clear sleeve (not shown) that simple slips over the combination of the electroluminescent panel 330 wrapped around the candle-shaped frame or any combination of the above.

The electroluminescent panel 330 is shown in the pre-assembly view of FIG. 3 as a panel having a length that is slightly less than the full length panel. However, a full length EL panel 330 may be used and still comport with the principles of the current invention. Not shown in FIG. 3 are the connections of the electroluminescent panel 330 to the controller 350. As mentioned above with respect to FIG. 2, one of skill in the art of electrical device assembly will easily recognize that the connections of the electroluminescent panel 330 can be made by routing the panel connections through a hole in the candle-shaped frame 320 to connect to the electronic controller 350. The light 315, configured to be generally inside the simulated flame 310, as well as the switch control 340 and batteries 360 are also interconnected to the controller 350 as is well understood by those of skill in the art. In the votive-style electroluminescent candle of the embodiment shown in FIG. 3, the switch 340 may also be a multiple function switch allowing different modes of control as indicated above with respect to switch 240 of FIG. 2. The switch 340 is conveniently located on the bottom plate 360 of the votive candle assembly of FIG. 3. However, as discussed before with respect to FIG. 1, the switch function may also be implemented as a membrane switch located in the electroluminescent panel 330 itself.

One feature of the invention is that the electroluminescent panel may be placed around a candle-shaped frame to result in the present invention. The candle-shaped frame may take many general forms including that of a taper candle, votive candle, tea candle, and pillar candle. Candle shapes may generally be thought of as having typically straight or slightly tapered sides or lengths and a base dimension. Thus an aspect ratio of length to height may be established. For example, using the taper candle shown in FIG. 2, the length to width aspect ration is 8.375/0.875=9.571. In FIG. 3, the length to width aspect ration is 2.25/1.75=1.28. A typical tea light candle may have an aspect ration of 1.75/1.5=1.17. A typical pillar candle may have an aspect ratio of 6.0/3.5=1.71. A pillar candle having a square cross-section may have an aspect ratio of 1.0/1.0=1.0 Generally, it is preferred that the length to width aspect ratio is that representing a candle and is between 15.0 and 0.5. As another aspect of the invention, the candle shaped frame need not be round. Shapes such as an oval or ellipse or a tear drop cross-section may be used as long as the electroluminescent panel material may be wrapped around the candle-shaped frame without damaging the EL panel. As a result a cone-shaped candle frame may also be used with an appropriately shaped EL panel.

In another embodiment, the candle-shaped frame may be a multisided geometric figure such as a triangle, square, hexagon, half sphere, etc. In these instances, an electroluminescent panel may be placed on one or more surfaces of the candle-shaped frame. Thus, multiple electroluminescent panels having different designs or patterns may be placed on any of the flat or curved sides of the EL candle. For example, a square pillar candle may have one, two, three, or four electroluminescent panels attached to the candle-shaped frame.

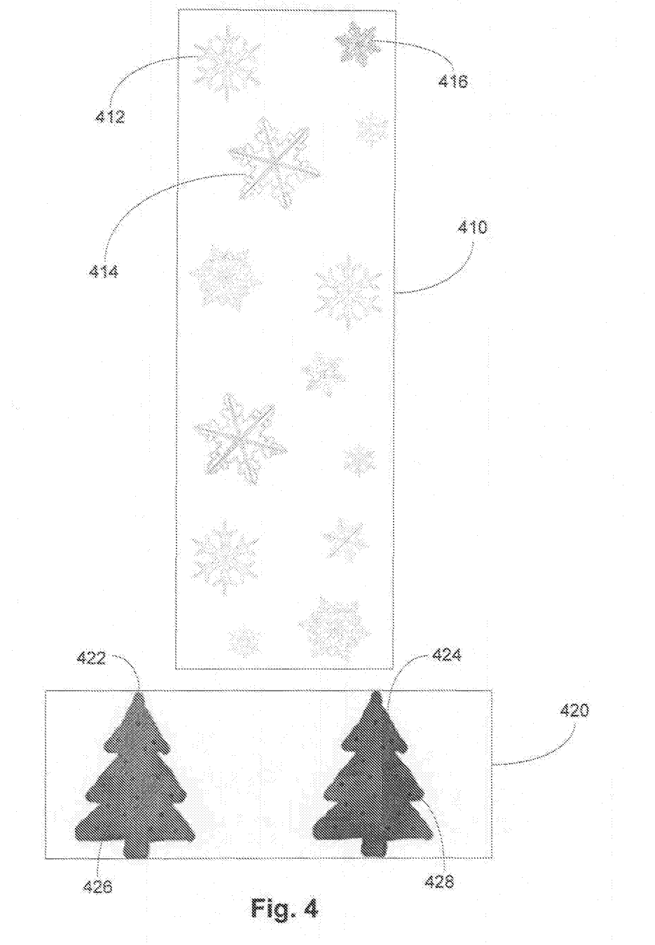

FIG. 4 depicts two example electroluminescent panel designs. Panel 410 is an EL panel design intended for a taper candle configuration as shown in FIGS. 1 and 2. It is shown with 13 separate elements (shown as separate snowflakes). Examples of the individual, separate elements are items 412, 414, and 416. Each element may be of a different design and color. One of skill in the art will appreciate that fewer or more of the individual items may be fabricated into the EL panel 410. As such each element or a set or grouping of elements may be separately illuminated using the separate wiring for each of the EL design items. For example, in the design of FIG. 4, panel 410, each snowflake may be separately wired to a controller for separate illumination in some controlled pattern or sequence of illumination. Alternately, the EL panel 410 may be wired such that groups of snowflake items, such as all snowflakes of a particular size or snowflakes grouped in a particular row may be wired for group-level illumination. In this instance, illumination of a group of design items may occur using the wired control resulting from the electrical interconnection of the selected group.

The EL panel 420 is an example of a panel design having at least two separate major design items 422 and 424, where each major items may have multiple sub-items 426 and 428. In the case of design 422, shown as an evergreen tree, a plurality of lights 426 (typical) may be separately illuminated items. A similar element is shown as evergreen tree item 424 and its plurality of lights 428 (typical). As described above, each separate light or evergreen tree item may be illuminated as a group or individually in a sequence determined by an electrical controller.

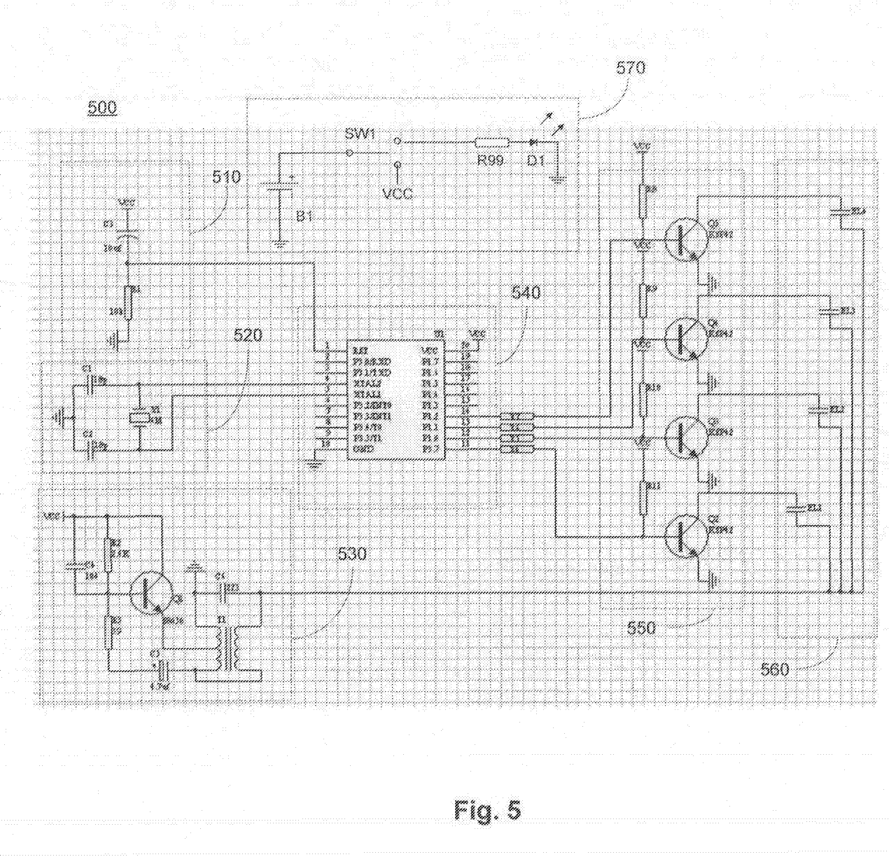

FIG. 5 is one example control circuit 500 for the current invention. The major functional areas of the circuit 500 include a reset circuit 510, a crystal oscillator, 520, a DC to AC inverter 530, a controller device 540, driver circuitry 550, and switch and light emitting device, such as an LED circuitry 570. The control circuit 500 is only one example of such a circuit and many variations are possible as is well known by those of skill in the art.

Considering the example circuit of FIG. 5, a programmable logic device or custom ASIC may be used for the controller device 540. As such, the number of interfaces the controller device 540 has may vary according to the number and complexity of the individual EL panel items (such as 412-414) that are to be driven. Also affecting complexity is the desired sequencing of those EL panel items. Such details are considered design choices and are well within the scope of the art for any programmable logic device designer. Given a programmable logic device 540, some support circuitry such as a crystal oscillator circuit 520 and a power on reset circuitry 510 may be necessary. However, these support circuitry needs are dependent upon the control device 540 selected and may be eliminated if the control circuit 540 includes them within its packaging.

Electroluminescent panels are actuated by placing a high AC voltage across the capacitor-like elements that are to be illuminated 560 (see FL1, FL2, FL3, and FL4). If a source of DC power, such as a battery, is used to power an EL candle, then a DC to AC inverter circuit is needed. One example is given in circuit 530 of FIG. 5. The AC output is provided to one side of all electroluminescent panel elements 560 (FL1-FL4). The return side is controlled via a group of solid state switches 550, (such as transistors Q2-Q5). The solid state switches 550 are actuated via the control circuit 540 in sequence or pattern that comports with the desired operational design of the El candle. Switch circuitry 570 is a simplified embodiment of an on/off switch showing a LED which operates when VCC is applied via the switch. In this example, the power source is a battery. As stated above, variation in the design of the controller circuitry 500 are well within the scope of the art and are within the scope of the present invention. In an embodiment where 120 V AC line voltage is used instead of a battery, the inverter circuit 530 would not be necessary, but a low voltage regulator for the Vcc driving the controller device 540 would be needed as is easily understood by those of skill in the art.

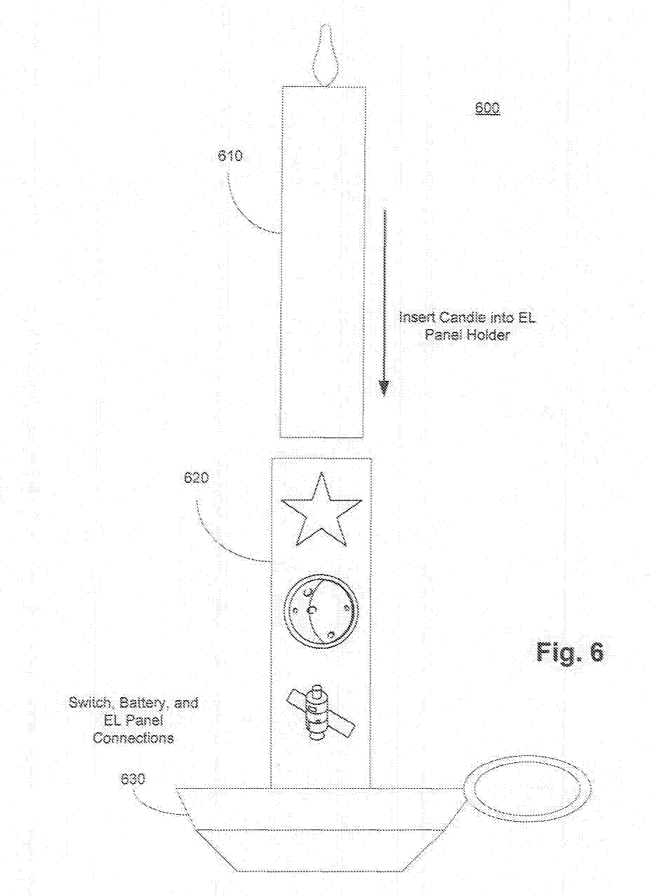

FIG. 6 illustrates an alternative embodiment 600 of the EL candle configuration of the present invention. In this embodiment, an electroluminescent panel 620 as a sleeve into which a real or artificial candle 610 may be placed. For example, in this embodiment, the electroluminescent panel 620 may be rolled into a circular form into which a circular candle 610 may be inserted. One of skill in the art will recognize that any candle cross section shape may be accommodated with a correspondingly shaped EL panel. The embodiment of FIG. 6 may also include candle holder or base 630 into which the electroluminescent panel 620 is mounted and electrically connected. In this embodiment 600, the batteries or other power source and electronics may reside in the candle holder base 620.

These and other advantages of the present invention will be apparent to those skilled in the art from the foregoing specification. Accordingly, it will be recognized by those skilled in the art that changes or modifications may be made to the above described embodiments without departing from the broad inventive concepts of the invention. It should therefore be understood that this invention is not limited to the particular embodiments described herein, but is intended to include all changes and modifications that are within the scope and spirit of the invention.

1. An electric candle that simulates a wax candle, the electric candle comprising:
a candle-shaped frame having a top end, a bottom end, and a length, the candle-shaped frame simulating a candle body of the wax candle;
a light emitting device affixed to the upper end of the candle-shaped frame to simulate light from a flame, the light emitting device simulating a flame portion of the wax candle;
an electroluminescent panel wrapped around the candle-shaped frame, the electroluminescent panel positioned below the light emitting device; and
an electronic control unit which actuates the light emitting device and the electroluminescent panel, the panel acting to illuminate the electric candle along a portion of the length of the candle-shaped frame.

2. The electric candle of claim 1, wherein the candle shaped frame comprises a frame having one of a taper candle shape, a tea light candle shape, a pillar candle shape, a votive candle shape, and a geometric candle shape.

3. The electric candle of claim 1, wherein the light emitting device comprises one of a light emitting diode, a neon light, an incandescent bulb, and an electroluminescent panel.

4. The electric candle of claim 1, wherein the electroluminescent panel comprises a panel having a plurality of separately illuminated fixed patterns.

5. The electric candle of claim 4, wherein the electronic control unit comprises sequentially actuated drivers for the plurality of separately illuminated fixed patterns.

6. The electric candle of claim 5, wherein the electronic control further comprises a driver providing a constant illumination level for the light emitting device.

7. The electric candle of claim 1, further comprising a switch for controlling applied power to the electric candle.

8. The electric candle of claim 7, wherein the switch is operated by IR or FM transmission outside of the device.

9. The electric candle of claim 7, wherein the switch is integrated into the bottom end of the electric candle.

10. The electric candle of claim 7, wherein the switch comprises a membrane switch integrated into the electroluminescent panel.

11. The electric candle of claim 7, wherein the switch further provides both separate and combined control of the light emitting device and the electroluminescent panel.

12. The electric candle of claim 7, wherein the switch is operated by an apparatus comprising one of a timer, a sound sensor, a motion sensor, a light sensor, and a touch sensor.

13. The electric candle of claim 1, wherein the electroluminescent panel comprises one of a flat flexible panel and a pre-formed candle-shaped panel.

14. The electric candle of claim 1, further comprising at least one integral battery.

15. The electric candle of claim 1, further comprising a power source derived from standard 120 VAC power.

16. The electric candle of claim 1, wherein an aspect ratio of the candle-shaped frame is between 0.5 and 15.0.

17. An electric candle that simulates a wax candle, the electric candle comprising:
an electroluminescent panel formed to accept a candle-shaped item, the candle-shaped item simulating a candlestick shaft of the wax candle;
a base onto which the formed electroluminescent panel is attached; and
an electronic control unit which actuates the electroluminescent panel, the electronic control unit acting to illuminate the electroluminescent panel along a portion of a length of the candle-shaped item representing the candlestick shaft of the wax candle, the candle-shaped item positioned below a simulated flame of the electric candle.

18. The electric candle of 17, wherein the base houses the electronic control unit, and power source.

19. The electric candle of claim 17, wherein the electroluminescent panel comprises a panel having a plurality of separately illuminated fixed patterns.

20. The electric candle of claim 17, wherein the electronic control unit comprises sequentially actuated drivers for the plurality of separately illuminated fixed patterns to generate a simulated animation of a pattern object.
